(19) United States
(12) Patent Application Publication
(10) Pub. No.: US 2004/0190949 A1
(43) Pub. Date: Sep. 30, 2004

(54) Developing roll

(75) Inventors: Kazushi Yamaguchi, Komaki-shi (JP); Mitsuyoshi Kondo, Komaki-shi (JP); Akihiko Kaji, Inazawa-shi (JP); Yasuki Ohtake, Susono-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/812,077

(22) Filed: Mar. 30, 2004

(30) Foreign Application Priority Data
Mar. 31, 2003 (JP) JP2003-094899

(51) Int. Cl. G03G 15/08

(52) U.S. Cl. 399/286

(57) ABSTRACT

A developing roll, which can reduce residual charge even under environment of low temperature and low humidity, comprises a shaft 1, an innermost layer 2, an intermediate layer 3 and an outermost layer 4 provided in this order on an outer peripheral surface of the shaft, the intermediate layer including an ionic conductive agent and carbon black and having a volume resistivity (ρv) of not more than 1.0×10⁶Ω·cm and the outermost layer having a volume resistivity (ρv) of 1.0×10⁷ to 1.0×10¹³ Ω·cm.

### BACKGROUND OF THE INVENTION

1. Field of the Invention

The present invention relates to a developing roll for use in an electrophotographic apparatus such as a copying machine or a printer.

2. Description of the Art

In an electrophotographic apparatus, an image forming operation is generally performed by forming an electrostatic latent image of an original image on a surface of a photoreceptor drum, causing a toner to adhere to the electrostatic latent image to form a toner image, transferring the toner image onto a sheet, and fixing the toner image on the sheet. For the formation of the toner image, a toner is supplied onto a surface of a developing roll from a toner cartridge by a toner supply roll, and electrically charged by means of friction between the surface of the developing roll and an opposite layer-forming blade while a toner layer is formed on the surface of the developing roll, and then the toner of the toner layer is adhered to the electrostatic latent image of the photoreceptor drum.

Good transferability of a toner is one of properties required for the developing roll and takes an important role for obtaining a good copied image. A proposed developing roll comprised a shaft, an innermost layer, an intermediate layer and an outermost layer, formed in this order on an outer periphery of the shaft, wherein the volume resistivity (ρv) of the intermediate layer is less than 10⁶Ω·cm and the volume resistivity (ρv) of the outermost layer is within a range of 10⁷ to 10¹²Ω·cm (see Japanese Unexamined Patent Publication No. 8-190263 (1996)). By use of this developing roll, residual charge can be reduced so that transferability of a toner becomes enhanced so that a good copied image can be obtained.

By use of such a developing roll, good results can be obtained under the environment of ordinary temperature (about 23° C.) and ordinary humidity (about 53%). However, there slightly remains room for improvement in obtaining a good copied image under the environment of low temperature (about 15° C.) and low humidity (about 10%) due to increased residual charge.

In view of the foregoing, it is an object of the present invention to provide a developing roll which can reduce residual charge even under the environment of low temperature and low humidity.

### SUMMARY OF THE INVENTION

According to the present invention and to achieve the aforesaid objects, there is provided a developing roll comprising a shaft, an innermost layer provided on an outer peripheral surface of the shaft, an intermediate layer provided on an outer peripheral surface of the innermost layer, and an outermost layer provided on an outer peripheral surface of the intermediate layer, the intermediate layer including an ionic conductive agent and carbon black and having a volume resistivity (ρv) of not more than 1.0×10⁶Ω·cm, and the outermost layer having a volume resistivity (ρv) of 1.0×10⁷ to 1.0×10¹³Ω·cm.

The inventors of the present invention conducted intensive studies on materials or the like of a developing roll to reduce residual charge of the developing roll under the environment of low temperature and low humidity. As a result, they discovered that, in a developing roll including an innermost layer, an intermediate layer and an outermost layer formed in this order on an outer periphery of a shaft, when the intermediate layer includes an ionic conductive agent and carbon black and has a volume resistivity (ρv) of not more than 1.0×10⁶Ω·cm and the outermost layer has a volume resistivity (ρv) of 1.0×10⁷ to 1.0×10¹³Ω·cm, the above-mentioned object can be achieved. Thus, the inventors attained the present invention.

### BRIEF DESCRIPTION OF THE DRAWINGS

FIG. 1 is a cross-sectional view illustrating an exemplary developing roll according to the present invention; and

FIG. 2 is a perspective view illustrating a method and apparatus for measuring residual charge on an outermost layer of the developing roll of FIG. 1.

### DESCRIPTION OF THE PREFERRED EMBODIMENTS

The present invention will hereinafter be described in detail by way of an embodiment thereof.

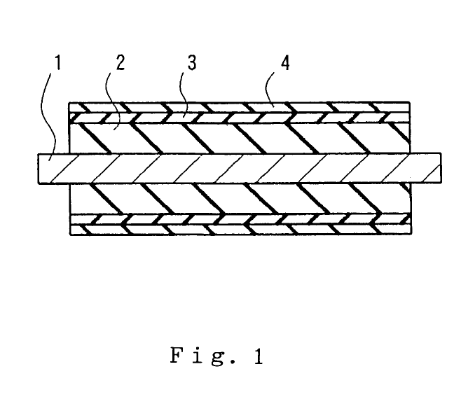

FIG. 1 shows an exemplary developing roll of the present invention. This developing roll includes a shaft 1, an innermost layer 2 provided on an outer peripheral surface of the shaft 1, an intermediate layer 3 provided on an outer peripheral surface of the innermost layer, and an outermost layer 4 provided on an outer peripheral surface of the intermediate layer. The intermediate layer includes an ionic conductive agent and carbon black and has a volume resistivity (ρv) of not more than 1.0×10⁶Ω·cm and the outermost layer has a volume resistivity (ρv) of 1.0×10⁷ to 1.0×10¹³Ω·cm.

The structure of shaft 1 is not particularly limited, but may be a solid core shaft or a hollow cylindrical shaft having a hollow interior, preferably made of metal. The shaft 1 may be composed of iron, plated iron, stainless steel, aluminum or the like. An adhesive, a primer or the like may be applied on the outer peripheral surface of the shaft 1, as required. Further, the adhesive, the primer or the like may be electrically conductive, as required.

A material for forming the innermost layer 2 is not particularly limited, however, examples thereof include silicone rubbers, ethylene-propylene-diene rubbers (EPDM), styrene-butadiene rubbers (SBR), butadiene rubbers (BR), isoprene rubbers (IR), acrylonitrile-butadiene rubbers (NBR) and polyurethane elastomers, which may be used either alone or in combination. Among all, silicone rubbers are preferred from the viewpoints of low hardness and reduced compression set.

The material for forming the innermost layer 2 may include one or more of a crosslinking agent, a vulcanizing agent, a foaming agent, a plasticizer, a softener, a tackifier, and an electrically conductive agent, as required.

A material for forming the intermediate layer 3 comprises a main component, as described below, an electrically ionic conductive agent and carbon black. Examples of the main component include hydrogenated acrylonitrile-butadiene rubbers (hydrogenated nitrile rubbers: H-NBR), acrylonitrile-butadiene rubbers (nitrile rubbers: NBR), polyurethane elastomers, chloroprene rubbers (CR), natural rubbers, butadiene rubbers (BR) and butyl rubbers (IIR), which may be used either alone or in combination. Among all, H-NBR is particularly preferred from the viewpoints of adhesion and stability of coating liquid.

Examples of the electrically ionic conductive agent include, for example, quaternary ammonium compounds; such as trimethyl octadecyl ammonium chloride, benzyl trimethyl ammonium chloride, trioctyl propylene ammonium chloride, trioctyl propyl ammonium bromide, trimethyl octadecyl ammonium perchlorate, tetrabutyl ammonium hydrogen sulfate and tetrabutyl ammonium hydroxide; and perchlorates, benzoates, nitrites, hydrosulfates and hydroxide salts thereof, which may be used either alone or in combination. Among all, tetrabutyl ammonium hydrogen sulfate and tetrabutyl ammonium hydroxide are preferred.

The ionic conductive agent may exert an effect under the environment of low temperature and low humidity so as to reduce residual charge, even if a small amount thereof is included into the main component of the material for forming the intermediate layer 3. However, the content of the ionic conductive agent is preferably within a range of 0.5 to 10 parts by weight (just abbreviated as parts, hereinafter) relative to 100 parts of the main component for forming the intermediate layer 3. Since the effect remains unchanged when the content exceeds 10 parts, there is no need to include over 10 parts. On the contrary, when the content is too much, the ionic conductive agent tends to exude into the outermost layer 4 so as to bring about the possibility of bloom.

The above-mentioned carbon black is not particularly limited and general-purpose carbon black may be used. Such carbon black is contained with the ionic conductive agent such that the volume resistivity (ρv) of the intermediate layer 3 falls within the required range of not more than 1.0×10⁶Ω·cm. The content of the carbon black is within a range of 20 to 50 parts relative to 100 parts of the main component for forming the intermediate layer 3.

The material for forming the intermediate layer 3 may also include one or more of a vulcanizing agent, a vulcanizing accelerator, a stearic acid, zinc oxide (ZnO), a softener and the like in addition to the ionic conductive agent and the carbon black.

A material for forming the outermost layer 4 comprises a main component, as described below, and electrically conductive agent. Examples of the main component include, for example, NBR, fluororubber, silicone-modified acrylic resin, acrylic resin, silicone resin, fluorocarbon resin, urethane resin, phenol resin, polyamide resin and epoxy resin, which may be used either alone or in combination. Among all, NBR is preferred because NBR has an electrically ionic conductivity due to polarity of the polymer itself and oil resistance for blocking oil or a plasticizer which will be transferred from the internal layers.

Examples of the electrically conductive agent include, for example, carbon black, graphite, potassium titanate, iron oxide, c-TiO₂, c-ZnO, c-SnO₂ and an ionic conductive agent, which may be used either alone or in combination. The prefix “c-” used above means “electrically conductive”. The volume resistivity (ρv) of the outermost layer 4 may be within a required range of 1.0×10⁷ to 1.0×10¹³Ω·cm by including the electrically conductive agent. The content of the electrically conductive agent is within a range of 0 to 20 parts relative to 100 parts of the main component for forming the outermost layer 4. In addition, one or more of a stabilizer, an ultraviolet absorber, an antistatic agent, a reinforcing agent, an electrostatic controller, a lubricant, a dye, a pigment, a flame retardant, oil and the like may be included therewith, as required.

The inventive developing roll may be produced, for example, as follows. Each material for forming the innermost layer 2, the intermediate layer 3 and the outermost layer 4 is prepared in the following manners. The material (compound) for forming the innermost layer 2 is prepared by kneading each component for forming the innermost layer 2 by means of a kneading means such as a kneader. The material (coating liquid) for forming the intermediate layer 3 is prepared by kneading each component for forming the intermediate layer 3 by means of a kneading means such as a ball mill or a roll, adding an organic solvent to the resultant mixture, and mixing and agitating thereof. The material (coating liquid) for forming the outermost layer 4 is prepared by kneading each component for forming the outermost layer 4 by means of a kneading means such as a ball mill or a roll, adding an organic solvent to the resultant mixture, and mixing and agitating thereof. Examples of the organic solvents include, for example, methyl ethyl ketone (MEK), methanol, toluene, isopropyl alcohol, methyl cellosolve, dimethylformamide, tetrahydrofuran and ethyl acetate, among which MEK is preferred from the viewpoint of solubility. These solvents are used either alone or in combination.

Then, a cylindrical mold for forming the innermost layer 2 and a shaft 1 are prepared. A mold release agent such as a wax is applied to an internal circumferential surface of the cylindrical mold and an adhesive or a primer is applied to an outer peripheral surface of the shaft 1, as required. In turn, the shaft 1 is installed as a center axis of the cylindrical mold in which a lower cap is covered. After filling the material (compound) for forming the innermost layer 2 into a space defined by the shaft 1 and the cylindrical mold, an upper cap is covered on the cylindrical mold. The entire mold covered with both the lower cap and the upper cap are put into an oven, and heated for vulcanizing the material (compound) for forming the innermost layer 2 on an outer peripheral surface of the shaft 1. Thereafter, the resultant product is removed from the mold. After removing from the mold, the thus obtained product may be secondarily vulcanized.

In turn, the material (coating liquid) for forming the intermediate layer 3 is applied to a peripheral surface of the innermost layer 2 by a roll coating method, dried and/or heated to form the intermediate layer. The material (coating liquid) for forming the outermost layer 4 is applied to a peripheral surface of the intermediate layer 3 by a roll coating method, dried and/or heated to form the outermost layer. Thus, the inventive developing roll is produced.

The thickness of the innermost layer 2 is not particularly limited, however, preferably it is within a range of 0.1 to 10 mm, particularly preferably within a range of 0.5 to 6 mm in the aforesaid embodiment. The thickness of the intermediate layer 3 is not particularly limited, however, preferably it is within a range of 3 to 30 μm, particularly preferably within a range of 5 to 20 μm. The thickness of the outermost layer 4 is not particularly limited, however, preferably it is within a range of 3 to 30 μm, particularly preferably within a range of 5 to 20 μm. Each thickness of the innermost layer 2, the intermediate layer 3 and the outermost layer 4 may be determined by measuring each thickness of a sectional specimen obtained from a developing roll by means of microphotograph. Further, the innermost layer 2, the intermediate layer 3 and the outermost layer 4 are formed in this order on an outer peripheral surface of the shaft 1 in the aforesaid embodiment, however, any other layer may be intervened between each two layers thereof or may be provided on an inner peripheral surface of the innermost layer 2 or on an outer peripheral surface of the outermost layer 4. Such layers may have either similar function with adjacent layers or different function therewith.

Next, an explanation will be given to Examples in accordance with the invention and Comparative Examples.

### EXAMPLE 1

To produce a developing roll, prepared were a shaft 1, a material (compound) for forming an innermost layer 2, a material (coating liquid) for forming an intermediate layer 3, a material (coating liquid) for forming an outermost layer 4 and a cylindrical mold for forming the innermost layer. An iron solid cylinder having a diameter of 8 mm was prepared as the shaft 1.

Preparation of Material (Compound) for Forming Inner most Layer 2

A material (compound) for forming an innermost layer 2 was prepared by kneading an electrically conductive silicone rubber (KE 1357. A/B available from Shin-Etsu Chemical Co., Ltd. of Tokyo, Japan) by means of a kneader.

Preparation of Material (Coating Liquid) for Forming Intermediate Layer 3

A material (coating liquid) for forming an intermediate layer 3 was prepared by kneading 0.1 parts of an ionic conductive agent (trimethyl octadecyl ammonium perchlorate), 50 parts of carbon black (Ketjenblack EC available from Lion Corporation of Tokyo, Japan), 0.5 parts of a stearic acid, 5 parts of zinc oxide (ZnO), 1 part of a vulcanizing accelerator (BZ; zinc di-n-butyldithiocarbamate), 2 parts of a vulcanizing accelerator (CZ; N-cyclohexyl-2-benzothiazolylsulfenamide) and 1 part of sulfur relative to 100 parts of H-NBR (Zetpole 0020 available from ZEON Corporation of Tokyo, Japan) by means of a ball mill, adding 400 parts of MEK thereto and mixing and agitating the thus obtained mixture.

Preparation of Material (Coating Liquid) for Forming Outermost Layer 4

A material (coating liquid) for forming an outermost layer 4 was prepared by kneading 10 parts of carbon black (Denka Black HS-100 available from Denki Kagaku Kogyo Kabushikikaisha of Tokyo, Japan) relative to 100 parts of a latex blend (Nipole DN-508 available from ZEON Corporation of Tokyo, Japan; 70 parts of NBR and 30 parts of polyvinyl chloride (PVC)) by means of a ball mill, adding 400 parts of MEK thereto and mixing and agitating the thus obtained mixture.

Production of Developing Roll

A developing roll was prepared in the same manner as in the aforesaid embodiment. In Example 1, the material for forming the innermost layer 2 was vulcanized at 190° C. for 20 minutes and the innermost layer 2 having a thickness of 5 mm was formed. The intermediate layer 3 was formed so as to have a thickness of 10 μm and the outermost layer 4 was formed so as to have a thickness of 15 μm. In the thus obtained developing roll, the volume resistivity (ρv) of the intermediate layer 3 was 1.0×10³Ω·cm and the volume resistivity (ρv) of the outermost layer 4 was 1.0×10⁷Ω·cm.

### EXAMPLE 2

A developing roll was produced in substantially the same manner as in Example 1, except that the content of the ionic conductive agent was 0.5 parts and the content of the carbon black was 35 parts in preparation of a material (coating liquid) for forming an intermediate layer 3. In the thus obtained developing roll, the volume resistivity (ρv) of the intermediate layer 3 was 2.0×10³Ω·cm and the volume resistivity (ρv) of the outermost layer 4 was 1.0×10⁹Ω·cm.

### EXAMPLE 3

A developing roll was produced in substantially the same manner as in Example 1, except that the content of the ionic conductive agent was 1 part and the content of the carbon black was 30 parts in preparation of a material (coating liquid) for forming an intermediate layer 3. In the thus obtained developing roll, the volume resistivity (ρv) of the intermediate layer 3 was 5.0×10³Ω·cm and the volume resistivity (ρv) of the outermost layer 4 was 1.0×10¹¹Ω·cm.

### Example 4

A developing roll was produced in substantially the same manner as in Example 1, except that the content of the ionic conductive agent was 5 parts and the content of the carbon black was 25 parts in preparation of a material (coating liquid) for forming an intermediate layer 3. In the thus obtained developing roll, the volume resistivity (ρv) of the intermediate layer 3 was 1.0×10⁴Ω·cm and the volume resistivity (ρv) of the outermost layer 4 was 1.0×10¹²Ω·cm.

### Example 5

A developing roll was produced in substantially the same manner as in Example 1, except that the content of the ionic conductive agent was 10 parts and the content of the carbon black was 20 parts in preparation of a material (coating liquid) for forming an intermediate layer 3. In the thus obtained developing roll, the volume resistivity (ρv) of the intermediate layer 3 was 1.0×10⁶Ω·cm and the volume resistivity (ρv) of the outermost layer 4 was 1.0×10¹³Ω·cm.

### Comparative Example 1

A developing roll was produced in substantially the same manner as in Example 1, except that the ionic conductive agent was not contained and the content of the carbon black was 30 parts in preparation of a material (coating liquid) for forming an intermediate layer 3. In the thus obtained developing roll, the volume resistivity (ρv) of the intermediate layer 3 was 1.0×10⁴Ω·cm and the volume resistivity (ρv) of the outermost layer 4 was 1.0×10¹²Ω·cm.

### Comparative Example 2

A developing roll was produced in substantially the same manner as in Example 1, except that the content of the ionic conductive agent was 1 part and the content of the carbon black was 15 parts in preparation of a material (coating liquid) for forming an intermediate layer 3. In the thus obtained developing roll, the volume resistivity (ρv) of the intermediate layer 3 was 1.0×10⁷Ω·cm and the volume resistivity (ρv) of the outermost layer 4 was 1.0×10¹⁴Ω·cm.

The residual charge for each of the thus obtained EXAMPLES 1 to 5 and COMPARATIVE EXAMPLES 1 and 2 was measured by the following manner and the quality of the copied images was evaluated. Such measurement and outputting of the copied images were conducted both under the environment of ordinary temperature (23° C.) and ordinary humidity (53%) and the environment of low temperature (15° C.) and low humidity (10%).

Measurement of Residual Charge

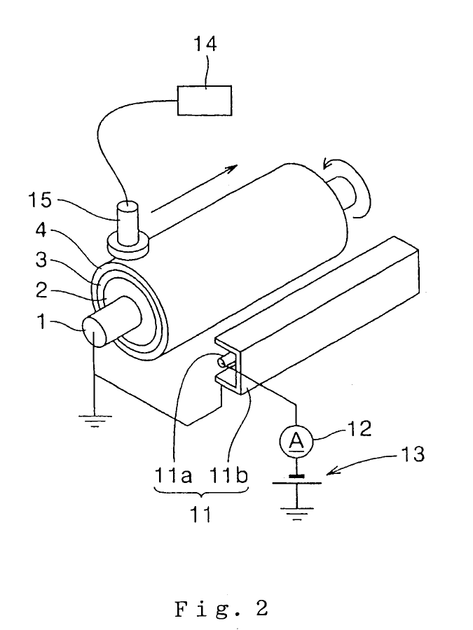

As shown in FIG. 2, a corotron (an electrifier) 11 was provided axially in parallel with a developing roll. The distance between a core 11a of the corotron 11 and a surface of the outermost layer 4 of the developing roll was set at 10 mm. The core 11a of the corotron 11 was connected with a minus side of a direct-current power supply 13 via a constant-current controller 12 (in which a constant-current was controlled to 100 μA) and a plus side of the direct-current power supply was grounded. A shield 11b of the corotron 11 was grounded with the shaft 1 of the developing roll. The surface of the outermost layer 4 was charged by the corotron 11 while the developing roll was rotated at 70 rpm circumferentially. The residual charge of the outermost layer 4 was measured at the position where 90 degrees was rotated circumferentially from the charging point. The measurement was conducted as a probe 15 (an electric potential detector) connected with a surface electrometer 14 (Model 541 available from TREK Japan, K.K. of Tokyo, Japan) was allowed to move axially at 8.7 mm/s within an area of the copied image of the outermost layer 4. At that time, the distance between the probe 15 and the outer peripheral surface of the outermost layer 4 was set at 1 mm. The maximum value of the residual charge was indicated by the surface electrometer 14 and each value thereof was shown in the following Table 1. In this context, “an area of the copied image” means such an area that a toner layer is formed and an intermediate portion excluding both opposite portions within 5 mm from both opposite distal ends of the outermost layer 4.

Density of Copied Image

Each developing roll of the thus obtained Examples 1 to 5 and Comparative Examples 1 and 2 was incorporated in a laser beam printer (LP-3000 available from EPSON Corporation of Tokyo, Japan) and images were actually printed. An image obtained after 10,000 sheets were printed was evaluated. The results of evaluation were shown in the following Table 1 in which the symbol ∘ indicates no density unevenness in the copied image, the symbol Δ indicates small density unevenness, however, which is inconspicuous, and the symbol X indicates considerable unevenness.

| | | | | Outermost | | | | |
|---|---|---|---|---|---|---|---|---|
| | Intermediate layer | | | layer | | | | |
| | Ionic | | Volume | Volume | Residual | | Evaluation of | |
| | conductive | Carbon | resistivity | resistivity | charge (V) | | copied image | |
| | agent | black | (Ω · cm) | (Ω · cm) | 23° C. 53% | 15° C. 10% | 23° C. 53% | 15° C. 10% |
| Example 1 | 0.1 parts | 50 parts | 1.0 × 10³ | 1.0 × 10⁷ | 30 | 60 | ∘ | Δ |
| Example 2 | 0.5 parts | 35 parts | 2.0 × 10³ | 1.0 × 10⁹ | 20 | 25 | ∘ | ∘ |
| Example 3 | 1 part | 30 parts | 5.0 × 10³ | 1.0 × 10¹¹ | 10 | 20 | ∘ | ∘ |
| Example 4 | 5 parts | 25 parts | 1.0 × 10⁴ | 1.0 × 10¹² | 10 | 20 | ∘ | ∘ |
| Example 5 | 10 parts | 20 parts | 1.0 × 10⁶ | 1.0 × 10¹³ | 10 | 20 | ∘ | ∘ |
| Comparative | — | 30 parts | 1.0 × 10⁴ | 1.0 × 10¹² | 30 | 400 | ∘ | x |
| Example 1 | | | | | | | | |
| Comparative | 1 part | 15 parts | 1.0 × 10⁷ | 1.0 × 10¹⁴ | 70 | 100 | Δ | x |
| Example 2 | | | | | | | | |

As can be understood from the results shown in Table 1, good copied images were obtained due to low residual charge under environment of low temperature (15° C.) and low humidity (10%) when using developing rolls of Examples 1 to 5. Since the amount of the electrically ionic conductive agent was low (0.1 parts), the copied image was slightly deteriorated under environment of low temperature and low humidity.

As mentioned above, the inventive developing roll comprises a shaft, an innermost layer provided on an outer peripheral surface of the shaft, an intermediate layer provided on an outer peripheral surface of the innermost layer and an outermost layer provided on an outer peripheral surface of the intermediate layer, the intermediate layer including an ionic conductive agent and carbon black and has a volume resistivity (ρv) of not more than 1.0×10⁶Ω·cm and the outermost layer has a volume resistivity (ρv) of 1.0×10⁷ to 1.0×10¹³Ω·cm. For this reason, residual charge can be reduced, thus good copied images can be obtained, even under environment of low temperature and low humidity by using the inventive developing roll.

Especially, when the content of the ionic conductive agent is within a range of 0.5 to 10 parts and the content of the carbon black is within a range of 20 to 50 parts, respectively, relative to 100 parts of the main component for forming the intermediate layer 3, residual charge of the developing roll can be further reduced under environment of low temperature and low humidity, resulting in better copied images.

What is claimed is:

1. A developing roll comprising a shaft, an innermost layer provided on an outer peripheral surface of the shaft, an intermediate layer provided on an outer peripheral surface of the innermost layer and an outermost layer provided on an outer peripheral surface of the intermediate layer, the intermediate layer includeing an ionic conductive agent and carbon black and having a volume resistivity (ρv) of not more than 1.0×10⁶Ω·cm and the outermost layer having a volume resistivity (ρv) of 1.0×10⁷ to 1.0×10¹³Ω·cm.

2. A developing roll as set forth in claim 1 wherein the ionic conductive agent is present in an amount of 0.5 to 10 parts by weight and carbon black is present in an amount of 20 to 50 parts by weight, respectively, relative to 100 parts by weight of a main component for forming the intermediate layer.
